(19) United States
(12) Patent Application Publication
(10) Pub. No.: US 2026/0220874 A1
(43) Pub. Date: Jul. 30, 2026

(54) A METHOD FOR GENERATING A SYNTHETICALLY AUGMENTED DEPTH, CONFIDENCE AND/OR SEGMENTATION IMAGE AS TRAINING DATA FOR TRAINING OF AN ARTIFICIAL NEURAL NETWORK

(71) Applicant: Sony Semiconductor Solutions Corporation, Kanagawa (JP)

(72) Inventors: Frederik WINDEY, Basingstoke (GB); Nicolas VAN DER NOOT, Basingstoke (GB)

(73) Assignee: Sony Semiconductor Solutions Corporation, Kanagawa (JP)

(21) Appl. No.: 19/144,592

(22) PCT Filed: Jan. 9, 2024
(86) PCT No.: PCT/EP2024/050384

§ 371 Date: Jun. 30, 2025

(30) Foreign Application Priority Data
Jan. 10, 2023 (EP) 23151007.4

(51) Int. Cl. G06T 15/06; G06V 10/26; G06V 20/70

(52) U.S. Cl. CPC G06T 15/06; G06V 10/26; G06V 20/70

(57) ABSTRACT

A method for generating a synthetically augmented depth image as training data for training of an artificial neural network comprising: generating a depth image of a synthetic object; and merging a real depth image of a scene with the generated depth image of the synthetic object to obtain the synthetically augmented depth image.

### TECHNICAL FIELD

The present disclosure generally pertains to the technical field of generating a synthetically augmented depth image as training data for training of an artificial neural network and to an artificial neural network obtained by being trained with a synthetically augmented depth image and a synthetically augmented segmentation image.

### TECHNICAL BACKGROUND

Object recognition or classification of objects in an image is an important task in many technical fields such as medicine or automotive, for example within an automotive functional safety application. Artificial neural networks (ANNs) are increasingly used to solve this task.

In general, the quality of an ANN depends on the number and quality of training data the network has been trained with. In the field of supervised learning, a training dataset consists of an input data (e.g. an input image) which is fed to the ANN and a corresponding label or a so-called ground truth which classifies each input data. During the training of the ANN, the result/output of the ANN is compared with the ground truth and according to the difference between the output and the ground truth, the (weights of the) ANN is adjusted and thus improved. The development of ground truth datasets often requires extensive manual effort through data labeling or classification of input data or correcting or sorting out bad or wrong ground truths. In order to train networks, diversity for ground truth is requested, but is difficult to get in large quantities.

An important step in the process of object recognition, which can be solved with the help of ANNs, is so-called image segmentation. In this process, content-related pixel regions are created within an image by combining neighboring pixels. For example, the images to be classified, can be 3D images comprising a depth component, for example stemming from a Time-of-flight (ToF) sensor. Therefore, to improve ANNs for image segmentation, improved ground truth datasets are required. However, the generation of training data sets with ground truth requires often a long and laborious process to be segmented when objects to segment are located close to each other (e.g., a car seat and steering wheel, relative to the driver body). Therefore, in particular, ground truth data with correct segmentation (i.e., labelized pixels) for objects close to each other are very important for training of an ANN.

Therefore, it is generally desirable to improve the generation of training data for ANNs.

### SUMMARY

According to a first aspect, the disclosure provides a method for generating a synthetically augmented depth image as training data for training of an artificial neural network comprising: generating a depth image of a synthetic object; and merging a real depth image of a scene with the generated depth image of the synthetic object to obtain the synthetically augmented depth image.

According to a second aspect the disclosure provides a method for training an artificial neural network with a synthetically augmented depth image and a synthetically augmented segmentation image, wherein generating the synthetically augmented depth image and the synthetically augmented segmentation comprises: generating a depth image of a synthetic object; and merging a real depth image of a scene with the generated depth image of the synthetic object to obtain the synthetically augmented depth image.

According to a third aspect the disclosure provides a device comprising circuitry configured to implement an artificial neural network obtained by being trained with a synthetically augmented depth image and a synthetically augmented segmentation image, wherein generating the synthetically augmented depth image and the synthetically augmented segmentation comprises: generating a depth image of a synthetic object; and merging a real depth image of a scene with the generated depth image of the synthetic object to obtain the synthetically augmented depth image.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically shows the basic operational principle of an indirect Time-of-Flight imaging system which can be used for depth sensing;

FIG. 2 shows in a schematic way the determination of the phase value between the emitted and the received light from the IQ measurement;

FIG. 3 shows a generic artificial neural network;

FIG. 4 shows a flow chart of a background subtraction algorithm;

FIG. 5 shows a flow chart of generating augmented images for ANN training;

FIG. 6 shows an example of a 3D model of a scene;

FIG. 7 shows the basic principle of ray tracing;

FIG. 8 shows a flowchart synthetic image generation of a modeled object;

FIG. 9 shows a flowchart of a transient rendering process to obtain a transient image

FIG. 10 shows a histogram of simulated measurement values Mᵢ(n) of a transient rendering process as described in FIG. 7;

FIG. 11 shows the flow chart of an applying sensor model to the transient image;

FIG. 12 shows a flow chart of a merging of real image data and synthetic image data;

FIG. 13. Shows a real image and a synthetically augmented image;

FIG. 14 schematically describes an embodiment of an electronic device which may implement the functionality of an artificial neural network; and

FIG. 15 is a block diagram depicting an example of schematic configuration of a vehicle control system.

### DETAILED DESCRIPTION OF EMBODIMENTS

The embodiments described below in more detail disclose a method for generating a synthetically augmented depth image as training data for training of an artificial neural network may comprise, generating a depth image of a synthetic object; and merging a real depth image of a scene with the generated depth image of the synthetic object to obtain the synthetically augmented depth image.

An artificial neural network may be any artificial neural network architecture. For example, a Convolutional Neural Networks, a Deep Neural Networks (DNN), a Recurrent Neural Networks, a Long short-term memory, a Deep belief network, a Stochastic Neural Networks, an Autoencoder, a Generative Adversarial Network or the like. An artificial neural network may comprise many layers, for example an input layer and an output layer. Each layer may for example comprise multiple (artificial) neurons. Each neuron may have an input and an output.

A real depth image of a scene may be an image of scene in the real world which is not virtually generated. A real depth image may be based on signals recorded by a camera sensor, for example an ToF camera.

Generating synthetically augmented depth images as training data for training of an artificial neural network may be beneficial within the context of an ANN used in a functional safety application. In order to lower the residual risk of safety functions (for example in the automotive or in the field of medicine) which are learned and trained based on a set of training data for an ANN, it is necessary to both increase the amount of training data for the ANN and also increase the amount of testing data. By increasing both the amounts of training and testing data sets validation processes may be fulfilled (the data set augmentation can even be set to a specific validation process). Such demanding validation process may be for example applicable for automotive functional safety, industrial applications, or even mobile applications and the like.

By synthetically generating augmented depth images as training data for training of an artificial neural network it can be generated a lot of complex ground truth data with little effort wherein segmentation often may be complex process. Further, objects close to each other may be segmented without pixels wrongly classified and there may be a realistic impression kept by merging real images and synthetic images.

According to the embodiments the method may further comprise generating a segmentation image of the synthetic object; and merging a real segmentation image of the scene with the generated segmentation. Segmentation in digital image processing and computer vision, may be the process of assigning a label to every pixel in an image such that pixels with the same label share certain characteristics.

There may be several methods of image segmentation. In one embodiment image segmentation may be performed by background subtraction (also called “foreground detection”). In background subtraction a previous frame is subtracted from a current frame in order to determine which pixels show a newly appeared object in the image. The subtraction is performed for each pixel within an image. In other embodiments, an ANN may be used for image segmentation, which receives an image (for example a depth image, or a confidence image, or a color image etc. or a combination thereof) as input and outputs a label segment for each pixel as output. In this case there may be no need to specify certain characteristics with regards to which the segmentation should be performed (like background and foreground) and therefore a human-kind image segmentation is approximated very good. For example, pulse-coupled neural networks (PCNNs) or convolutional neural networks (for example U-Net) or the like may be used. However, if a trained ANN is not available or an ANN is not yet properly trained other methods for image segmentation are available as well.

A real segmentation image may be a segmentation image that is based on a real image of a scene in the real world which is not virtually generated. The real image that the real segmentation image is based on may be a depth image or a color image or the like, which may be based on signals recorded by a camera sensor, for example an ToF camera.

According to the embodiments the method may further comprise generating a confidence image of the synthetic object; and merging a real confidence image of the scene with the generated confidence image.

A confidence image may be based on I and Q values for each pixel, generated by a ToF camera (see Eq. 19). A real confidence image may be a confidence image that is based on a real image of a scene in the real world which is not virtually generated. The real image that the real confidence image is based on may be a depth image, which may be based on signals recorded by a camera sensor, for example a ToF camera.

According to the embodiments the method may further comprise generating a RGB image of the synthetic object; and merging a real RGB image of the scene with the generated RGB image.

According to the embodiments the generating of a depth image comprises adapting an unadapted depth image of the synthetic object with regards to camera intrinsics and distortions of a camera taking the real depth image. An unadapted depth image of the synthetic object may be a synthetic object that is not yet adapted to specifics of a real camera sensor like distortions or camera intrinsics like specific optics or lenses.

In another embodiment this may be done during the rendering process (i.e. not as an extra step).

According to the embodiments the distortions of the camera taking the real depth image are due to thermal noise, shot noise, sensor scattering, tap imbalance and the camera intrinsic distortions are due to a fish-eye-lens optics of the camera.

The same distortions and camera intrinsics distortions may also occur in the confidence image, the segmentation image, color image etc.

According to the embodiments the generating of the depth image of the synthetic object may comprise adding noise to the position, orientation and/or scale of the synthetic object with regards to an optimal position, orientation and/or scale of the synthetic object.

The optimal position, scale and the orientation within the coordinate system may be predetermined and known in advance for example in a case where the camera is fixed to a certain position with known coordinates and a model of the synthetic object is modeled in a space with the same coordinates. This may be the case, if a fixed camera is mounted in a car cabin and the object is a model of the interior of the same car cabin which comprises the camera position which takes the real image.

According to the embodiments the merging of the real depth image of the scene with the generated depth image of the synthetic object may comprise comparing corresponding depth values of pixels of the real depth image and the generated depth image of the synthetic object.

According to the embodiments the respective pixel value with the lower depth value is set as the depth value of the synthetically augmented depth image.

The respective confidence value of the pixel with the lower depth value may be set as the confidence value of a synthetically augmented confidence image.

The respective segmentation value of the pixel with the lower depth value may be set as the segmentation value of a synthetically augmented segmentation image (also called ground truth data).

The respective color value of the pixel with the lower depth value may be set as the color value of a synthetically augmented segmentation image.

According to the embodiments a camera generating the real depth image of the scene may be a time-of-flight camera.

The real depth image may be generated by a range imaging camera system like may be a Time-of-Flight camera, for example an indirect ToF (iToF) or a direct ToF (dToF) or a structured light camera, or a stereo-camera or the like.

According to the embodiments the generating of the depth image of the synthetic object may comprise performing a ray tracing process.

According to the embodiments the generating of the depth image may comprise performing a transient rendering process.

According to the embodiments the synthetic object may be a 3D mesh model.

The synthetic 3D object may be a model which is described by: A mesh, for example comprising reflectivity and/or texture components; a local or global voxel representation of a point cloud (uniform or octree); a local or global occupancy grid; a mathematical description of the scene in terms of planes, statistical distributions (e.g., Gaussian mixture models), or similar attributes extracted from the measured point cloud. According to the embodiments the synthetic object may comprise a surface reflectivity parameter and/or surface texture parameter. For example, the reflectivity parameters and texture parameter, may be parameters with regards to the Phong reflection model, that is the specular reflection constant kₛ, the diffuse reflection constant k_{d}, the ambient reflection constant kₐ and surface texture parameter γ.

According to the embodiments the synthetically augmented depth image may be used as training data for training of an artificial neural network for an automotive functional safety application.

An automotive functional safety application may be a hands on/off detection, which is a system that can determine whether or not the driver's hands are on the steering wheel rim. Further, an automotive functional safety application may be a head and eye tracker which monitors if a driver falls asleep.

Further, the embodiments described below in more detail disclose a method for training an artificial neural network with a synthetically augmented depth image and a synthetically augmented segmentation image, wherein generating the synthetically augmented depth image and the synthetically augmented segmentation may comprises, generating a depth image of a synthetic object; and merging a real depth image of a scene with the generated depth image of the synthetic object to obtain the synthetically augmented depth image. Further, the embodiments described below in more detail disclose a device comprising circuitry which may be configured to implement an artificial neural network obtained by being trained with a synthetically augmented depth image and a synthetically augmented segmentation image, wherein generating the synthetically augmented depth image and the synthetically augmented segmentation which may comprise, generating a depth image of a synthetic object; and merging a real depth image of a scene with the generated depth image of the synthetic object to obtain the synthetically augmented depth image.

Circuitry may include a processor (CPU, GPU etc.), a memory (RAM, ROM or the like), a data storage, input means (control buttons, keys), etc. as it is generally known for electronic devices (computers, smartphones, etc.). Moreover, it may include sensors for sensing still image or video image data (image sensor, camera sensor, video sensor, etc.), for sensing a fingerprint, for sensing environmental parameters (e.g. radar, humidity, light, temperature), etc.

Indirect Time-of-Flight Imaging System (iToF)

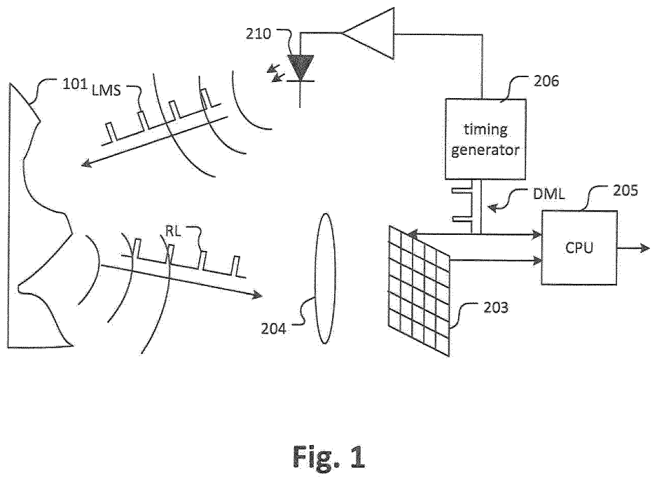

FIG. 1 schematically shows the basic operational principle of an indirect Time-of-Flight imaging system which can be used for depth sensing. The iToF imaging system includes an iToF camera with an imaging sensor 203 having a matrix of pixels and a processor (CPU) 205. A scene 101 is actively illuminated with amplitude-modulated infrared light LMS at a predetermined wavelength using an illumination device 210, for instance with some light pulses of at least one predetermined modulation frequency DML generated by a timing generator 206. The amplitude-modulated infrared light LMS is reflected from objects within the scene 101. A lens 204 collects the reflected light RL and forms an image of the scene 101 onto the imaging sensor 203. In indirect Time-of-Flight (iToF) the CPU 205 receives the ToF measurements and determines for each pixel a phase delay between the modulated signal DML and the reflected light RL and a depth value for each pixel as described below.

Consider an iToF camera pixel imaging an object at a distance D. A (differential) iToF pixel measurement ν(τ_{E},τ_{D}) as obtained in the iToF pixel is a variable whose expected value μ(τ_{E},τ_{D}) is given by

$$μ ( {τ}_{E} , {τ}_{D} ) = E ( v ( {τ}_{E} , {τ}_{D} ) ) = {\int }_{0}^{{T}_{I}} m ( t ) {ϕ}_{R} ( t , {τ}_{E} , {τ}_{D} ) d t \qquad ( Eq . l )$$

where, t is the time variable, Tᵢ is the exposure time (integration time), m(t) is the in-pixel reference signal which corresponds to the modulation signal (i.e. the emitted light signal) or a phase shifted version of the modulation signal. Φ_{R}( [symbol] ,τ_{E},τ_{D}) is the pixel irradiance signal which represents the reflected light captured by the pixel. τ_{E} represents a time variable indicative of the time delay between the in-pixel reference signal (modulation signal) and the emitted light, and τ_{D} is a time variable representing the time that it is required for the light to travel from the iToF camera to the object and back. Neglecting the parallax effect, the time variable τ_{D} is given by:

$${τ}_{D} = \frac{2 D}{c} \qquad ( Eq . 2 )$$

where D is the distance between the ToF camera and the object, and c is the speed of light.

The reflected light signal Φ_{R}( [symbol] ,τ_{E},τ_{D}) is a scaled and delayed version of the emitted light Φ_{E}( [symbol] −τ_{E}). The pixel irradiance signal Φ_{R}( [symbol] ,τ_{E} τ_{D}) is given by:

$${Φ}_{R} ( t , {τ}_{E ,} {τ}_{D} ) = Φ ( {τ}_{D} ) \times {Φ}_{E} ( t - {τ}_{E} - {τ}_{D} ) \qquad ( Eq . 3 )$$

where Φ(τ_{D}) is a real value scaling factor that depends on the distance D between the ToF camera and the object, and Φ_{E}( [symbol] −τ_{E}−τ_{D}) is the emitted light Φ_{E}( [symbol] −τ_{E}) additionally delayed with the time variable τ_{D}. In the context of iToF, both m(t) and φ_{E}(t) are typically periodical signals with period

$${T}_{M} = {f}_{m o d}^{- 1} ( {f}_{m o d}$$

being the fundamental frequency or modulation frequency generated by the timing generator. As Tₗ>>T_{M}, the expected differential signal μ(τ_{E},τ_{D}) is also a periodical function with respect to the electronic delay τ_{E} between in-pixel reference signal m(t) and optical emission Φ_{E}( [symbol] −τ_{E}) with the same fundamental frequency f_{mod}.

Writing μ(τ_{E},τ_{D}) in terms of its Fourier Coefficients Mₖ yields

$$μ ( {τ}_{E} , {τ}_{D} ) = Φ ( {τ}_{D} ) {\sum }_{k = - ∞}^{∞} ( {M}_{k} {e}^{j 2 π {kf}_{mod} {τ}_{D}} ) {e}^{j 2 π {kf}_{mod} {τ}_{E}} \qquad ( Eq . 4 )$$

Note that due to the distance-dependent scaling of the light (factor Φ(τ_{D})), the expected differential signal μ(τ_{E},τ_{D}) is not periodical with respect to the time-of-flight τ_{D}.

From the above it is clear that the time-of-flight, and hence depth, can be estimated from the first harmonic H₁(τ_{D}) of μ(τ_{E},τ_{D}):

$${H}_{1 , μ} ( {τ}_{D} ) = \int μ ( {τ}_{E} , {τ}_{D} ) {e}^{- j 2 π {f}_{mod} {τ}_{E}} d {τ}_{E} ∝ Φ ( {τ}_{D} ) {M}_{1} {e}^{j 2 π {f}_{mod} {τ}_{D}} \qquad ( Eq . 5 )$$

From the first harmonic H_{1,μ}(τ_{D}) the phase angle θ_{1,μ}(τ_{D}) is obtained as

$${θ}_{1 , μ} ( {τ}_{D} ) = ∠ {H}_{1 , μ} ( {τ}_{D} ) = 2 π {f}_{m o d} {τ}_{D} + {ψ}_{{M}_{1}} \qquad ( Eq . 6 )$$

$$with$$

$${ψ}_{{M}_{1}} = ∠ {M}_{1} \qquad ( Eq . 7 )$$

Here, ∠ denotes the phase of a complex number z=re^{iφ}

$$∠ z = ∠ ( {re}^{i ϕ} ) = ϕ \qquad ( Eq . 8 )$$

In practice, it is not feasible to evaluate H_{1,μ}(τ_{D}) due to the presence of noise and due to the number of transmit delays.

Concerning the presence of noise, H_{1,μ}(τ_{D}) is formulated in terms of the expected value μ(τ_{E},τ_{D}) of differential mode measurements ν(τ_{E},τ_{D}). Estimating this expected value from measurements may be performed by multiple repeated acquisitions (of static scene) to average out noise.

Concerning the number of transmit delays, H_{1,μ}(τ_{D}) is given as an integral over all possible transmit delays τ_{E}. Approximating this integral may require a high number of transmit delays.

Due to these reasons iToF systems measure an approximation of this first harmonic H_{1,μ}(τ_{D}). This approximation uses N differential mode measurements (i.e. N different measurements collected at N taps) ν(τ_{E,n},τ_{D}) (n=0, . . . , N−1) corresponding to N electronic transmit delays τ_{E,n}. A vectorized representation of this set of transmit delays is:

$${t}_{E} = {[ {τ}_{E , 0} … {τ}_{E , N - 1} ]}^{T} \qquad ( Eq . 9 )$$

The approximation of the first harmonic H_{1,μ}(τ_{D}) is obtained by an N-point EDFT (Extended Discrete Fourier Transform), according to

$${H}_{1 , v} ( {τ}_{D} ; {t}_{E} ) = {\sum }_{k = 0}^{N - 1} v ( {τ}_{E , n} , {τ}_{D} ) {e}^{- j 2 π \frac{n k}{N}} \qquad ( Eq . 10 )$$

with n being the N-point EDFT bin considered. In standard iToF, n=1. However, depending on the transmit delays selected, different values of n could be more appropriate. For simplicity and without loss of generality, we will assume n=1 in the remainder of this disclosure:

$${H}_{1 , v} ( {τ}_{D} ; {t}_{E} ) = {\sum }_{k = 0}^{N - 1} v ( {τ}_{E , n} , {τ}_{D} ) {e}^{- j 2 π \frac{k}{N}} \qquad ( Eq . 11 )$$

This first harmonic estimate H_{1,ν}(τ_{D}; [symbol] _{E}) is also referred to as IQ measurement (with I and Q the real resp. imaginary part of the first harmonic estimate). In order to stay close to iToF nomenclature, in the following H_{1,ν}(τ_{D}; [symbol] _{E}) is denoted as “IQ measurement”. However, it is important to remember that an IQ measurement is an estimate of the first harmonic H_{1,μ}(τ_{D}) of the expected differential measurement (as function of transmit delay).

From the first harmonic estimate H_{1,ν}(τ_{D}; [symbol] _{E}) of equation Eq. 11, the phase value φ between the emitted and the received light is obtained as

$$ϕ = a tan 2 ( \frac{Im ( {H}_{1 , v} ( {τ}_{D} ; {t}_{E} ) )}{Re ( {H}_{1 , v} ( {τ}_{D} ; {t}_{E} ) )} ) \qquad ( Eq . 12 )$$

with Im( ) and Re( ) being respectively the imaginary part and the real part operator, and arctan 2 being the 4-quadrant inverse tangent function.

Due to the statistical nature of the differential mode measurements ν(τ_{E,n},τ_{D}), the IQ measurement H_{1,ν}(τ_{D}; [symbol] _{E}) is a random variable with the following expected value

$$E ( {H}_{1 , v} ( {τ}_{D} ; {t}_{E} ) ) ≡ {H}_{1 , μ} ( {τ}_{D} ; {t}_{E} ) = {\sum }_{k = 0}^{N - 1} μ ( {τ}_{E , n} , {τ}_{D} ) {e}^{- j 2 π \frac{k}{N}} \qquad ( Eq . 13 )$$

This expected value is here referred to as expected IQ measurement.

With

$$F ( 1 ) = E ( {H}_{1 , v} ( {τ}_{D} ; {t}_{E} ) ) \qquad [ Eq . 14 ]$$

denoting the IQ measurement, and

$${q}_{n} = μ ( {τ}_{E , n} , {τ}_{D} ) \qquad ( Eq . 15 )$$

denoting the N measurements (samples) obtained by the pixel at respective phases, this gives:

$$F ( 1 ) = {\sum }_{k = 0}^{N - 1} {q}_{n} {e}^{- j 2 π \frac{k}{N}} \qquad ( Eq . 16 )$$

Specifically, once the Fourier transform is computed on the samples of the correlation waveform, the first harmonic will contain I and Q information as its real and imaginary part, respectively, that is I=Im(F(1)) and Q=Re(F(1)).

Based on equation Eq. 12 the phase value φ between the emitted and the received light is obtained as:

$$ϕ = arc tan 2 ( \frac{I}{Q} ) . \qquad ( Eq . 17 )$$

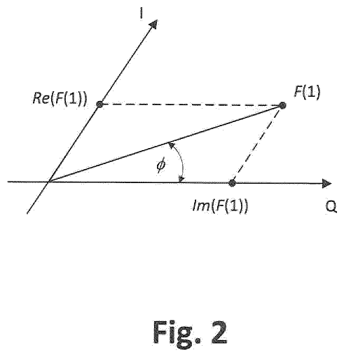

FIG. 2 shows in a schematic way the determination of the phase value φ between the emitted and the received light from the IQ measurement F(1) (sometimes also denoted as “phasor” or “phasor image”) as set out in Eq. 17. The imaginary part Im(F(1)) of the IQ measurement F(1) denotes the Q component of the IQ measurement F(1). The real part Re(F(1)) of the IQ measurement F(1) denotes the I component of the IQ measurement F(1). The phase value φ is obtained from the Q component and I component of the IQ measurement F(1) according to trigonometric principles.

Based on the phase value φ according to equation Eq. 17 the corresponding depth value d for each pixel is determined as follows:

$$d = \frac{c}{4 π {f}_{M}} ϕ \qquad ( Eq . 18 )$$

with f_{M} being the modulation frequency of the emitted signal and c being the speed of light. An image which comprises a depth value for each pixel is called depth image or depth map.

The confidence value conf for each pixel is determined as follows:

$$conf = \vert I \vert + \vert Q \vert \qquad ( Eq . 19 )$$

### Image Segmentation

In digital image processing and computer vision, the process of assigning a label to every pixel in an image such that pixels with the same label share certain characteristics, is called image segmentation. The result of image segmentation is a set of segments that collectively cover a part of the image or the entire image and where each of the pixels in a segment are similar with respect to some characteristic, such as color, intensity, depth, confidence value, texture etc. Therefore, the results of a segmentation process may be a segmentation image, which comprises a label for each pixel. The label may for example be a number for each pixel, the number referring to a corresponding segment. When applied in the context of machine vision after an image segmentation, a feature extraction and a classification may be applied to an image. In an automotive environment the segments may be a driver, a seat, a steering wheel. In a medical environment the segments may be a lung, liver, heart etc.

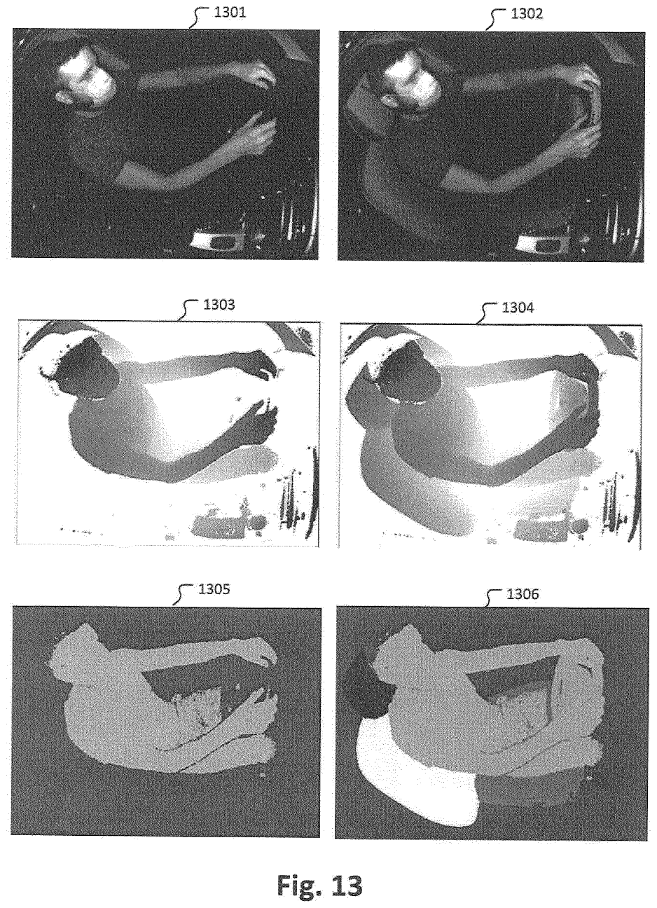

Segments of an image may be visualized by assigning a different color, gray level, or texture to each segment and thereby illustrating the corresponding different segments within an image (see eg. 1305 and 1306 in FIG. 13 below).

There are several different methods of image segmentation. For example, an ANN can be used, which receives an image (for example a depth image, or a confidence image, or a color image etc. or a combination thereof) as input and outputs a label segment for each pixel as output. In this case there is no need to specify certain characteristics with regards to which the segmentation should be performed (like background and foreground) and therefore a human-kind image segmentation is approximated very good. For example, pulse-coupled neural networks (PCNNs) or convolutional neural networks (for example U-Net) or the like may be used.

An example of image segmentation using deep learning ANNs is for example described in the scientific paper “Image segmentation using deep learning: A survey.”, by Minaee, Shervin, et al., published in IEEE transactions on pattern analysis and machine intelligence (2021).

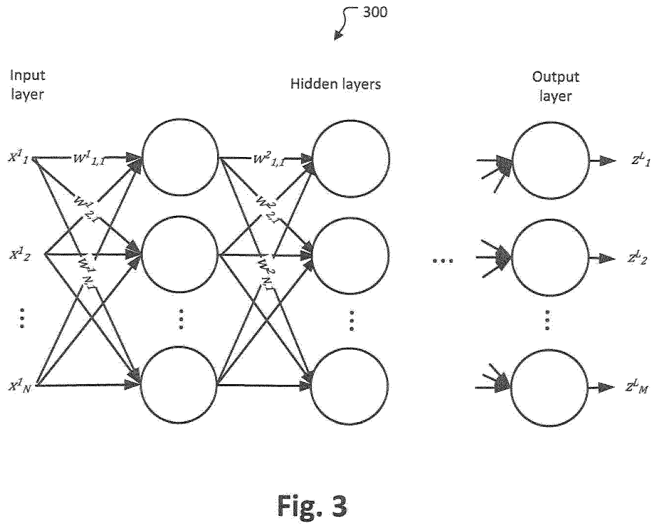

FIG. 3 shows, for illustrative purpose, a generic artificial neural network 300. The neural network 300 has one input layer, one output layer and several hidden layers between the input layer and the output layer. Altogether the neural network has L layers. This is an example of a “fully-connected ANN”, i.e., an ANN where all layers are comprised of fully-connected/densely connected/affine layers. The input layer has N input elements

$${x}_{1}^{( 1 )} to {x}_{N}^{( 1 )} .$$

The output layer has M output elements

$${z}_{1}^{( L )} to {z}_{M}^{( L )} .$$

The dimension of the output vector M and the dimension of the input vector N can be equal or different. The weights of the neural network are denoted as

$${w}_{1 , 1}^{( 1 )} to {w}_{N , N}^{( 1 )} .$$

whereby the index l indicates the layer and the lower indices i,j indicate the neurons the weight is linking. For example, in the first layer the weights are denoted as

$${w}_{i , j}^{( l )} ,$$

In this embodiment, the activation functions in each neuron are chosen to be the same. The input to the activation function in the k-th neuron in the l-th layer is for example

$${\sum }_{i = 1}^{N} {w}_{k , i}^{( l )} {x}_{i}^{( l )} + {b}^{( l )} .$$

The activation function in the first neuron in the first layer is given by

$$ϕ ( {\sum }_{i = 1}^{N} {w}_{1 , i}^{( 1 )} {x}_{i}^{( 1 )} + {b}^{( 1 )} ) . {b}^{l}$$

is a so-called bias term, which is a constant term that can be added to the input term

$${\sum }_{i = 1}^{N} {w}_{k , i}^{( l )} {x}_{i}^{( l )}$$

in order to shift the activation function to the left or to the right. The bias term b^{(l)} is a vector because the bias can be different for each neuron. The activation function φ can for example be the rectified linear function (ReLU), the step function, the arctan, the tanh, the logistic function, the identity function or many more.

For example, during interference a depth image is fed as input data into the ANN and as an output each pixel of the depth images is labeled. That means the N input elements

$${x}_{1}^{( 1 )} to {x}_{N}^{( 1 )}$$

are a depth values (or a confidence value, or a colour-intensity value or a combination thereof or the like) of each pixel of an image for example obtained by an ToF sensor (see FIGS. 1 and 2). The M output elements

$${z}_{1}^{( L )} to {z}_{M}^{( L )}$$

are different segments (labels) for each pixel of the input image. For example, a softmax function may be used in the output layer.

In another embodiment, the ANN may comprise K output layers (K being the number of segmentation classes to recognize, e.g., the steering wheel class), wherein for each of these K layers, each point is a pixel, and its value is a likeliness to belong to the corresponding class.

During a training phase (e.g. via supervised learning), the ANN is trained by adapting the weights

$${w}_{k , i}^{( l )}$$

such that the error between label of a pixel of input image (i.e. the ground truth that is the label) and the label that is determined by the ANN for a pixel is minimized. That may be achieved according to a minimization of a total loss function, using standard error backpropagation techniques. In this way, an ANN can be trained to perform image classification.

If a trained ANN is not available for image segmentation, or an ANN is not yet properly trained other methods for image segmentation are available as well. Algorithms for image segmentation are for example mentioned in the scientific paper “Image segmentation algorithms overview.”, by Yuheng, Song, and Yan Hao., published in arXiv preprint arXiv: 1707.02051 (2017), and the papers mentioned therein.

An exemplifying technique for image segmentation is the so-called background subtraction (also called “foreground detection”). In background subtraction a previous frame (time step n−1) is subtracted from a current frame (time step n) in order to determine which pixels show a newly appeared object in the image. The subtraction is performed for each pixel within an image.

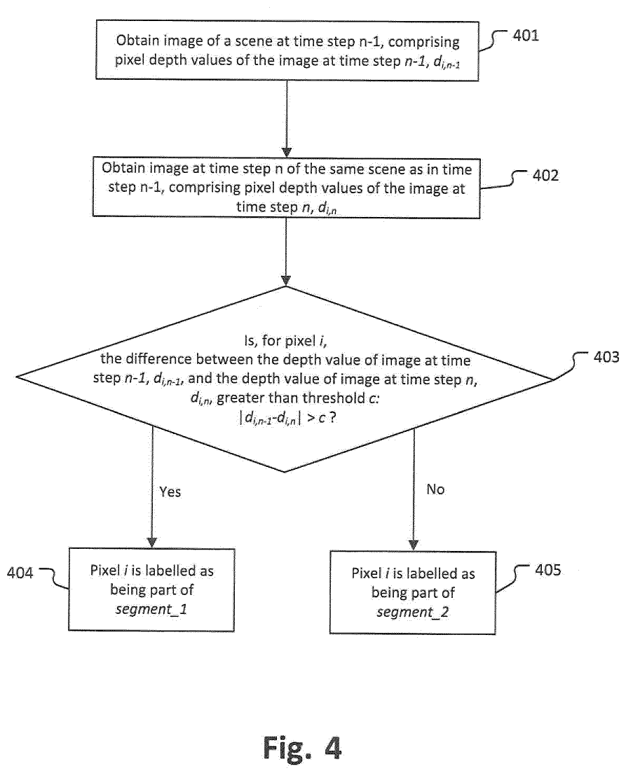

FIG. 4 shows a flow chart of a background subtraction algorithm. In step 401 a depth image of a scene at a time step n−1 is obtained, comprising pixel depth values of the image at time step n−1, d_{i,n-1}. In step 402 a depth image of the same scene at a time step n is obtained, comprising pixel depth values of the image at time step n, d_{i,n}. At step 403 it is asked if, for pixel i, the difference between the depth value of the image at time step n−1, d_{i,n.1}, and the depth value of the image at time step n, d_{i,n}, greater than a threshold c: |d_{i,n-1}−d_{i,n}|>c? If the answer in step 403 is yes, the process continues with step 404. In step 404, the pixel i is labelled as being part of a segment segment_1. For example, segment segment_1 is an object that has moved into the scene, that is for example a foreground object. If the answer in step 403 is no, the process continues with step 405. In step 405, the pixel i is labelled as being part of a segment segment_2. For example, segment segment_2 is an object that has not moved within the scene, that is a for example a background object.

For example, the scene that is imaged at consecutive time steps is an interior of a car. Segment segment_1 may be a driver that has appeared within the car and segment segment_2 may be the cabin of the car like the seat etc.

In another embodiment, the background subtraction algorithm described above, is operated with a depth map recorded at a “step 0” (n=0) (where it is known that there is only background, e.g., before a person enters into the car), instead of an ever-changing depth map at “step n−1”. In this case the above formula in step 403 would be: d_{i,n}≤d_{i,0}+c. If the answer in this step 403 is yes, then the corresponding pixel is foreground, and if the answer is no than the corresponding pixel is background (note: no absolute value would be needed here). That means, if the current pixel depth d_{i,n} is closer (smaller) to the camera than the background with tolerance d_{i,0}+c then it is foreground and otherwise, it is background.

In another embodiment instead or additional to the depth value comparison at pixel i between time step n−1 and n, a confidence value, or a color intensity value or the like may be performed.

Further, the other images, for example a depth image, or a confidence image, or a color image etc. can be labeled with the corresponding segment for each pixel additional to the depth/confidence/color information. This yields a data set with labeled depth/confidence/color images. These labelled data sets can be used for (supervised) learning/training of an ANN.

### Augmenting Training Data for ANNs

In order to train artificial neural networks, data sets with a diversity for ground truth is requested but it may be difficult to obtain these data sets in large quantities. Therefore, in the embodiments disclosed here, images of a real scene (for example images comprising depth values, or confidence values, a segmentation label or color values or the like), which are for example taken by a ToF camera or the like interior of a vehicle, are augmented with synthetic objects to yield augmented images that can be positioned and scaled to fit realistic situations. Thereby, this provides improved ground truth datasets. In particular, ground truth data is generated with correct segmentation (i.e., labelized pixels) for objects within the image close to each other (e.g., a car seat and a steering wheel, relative to the body of the driver).

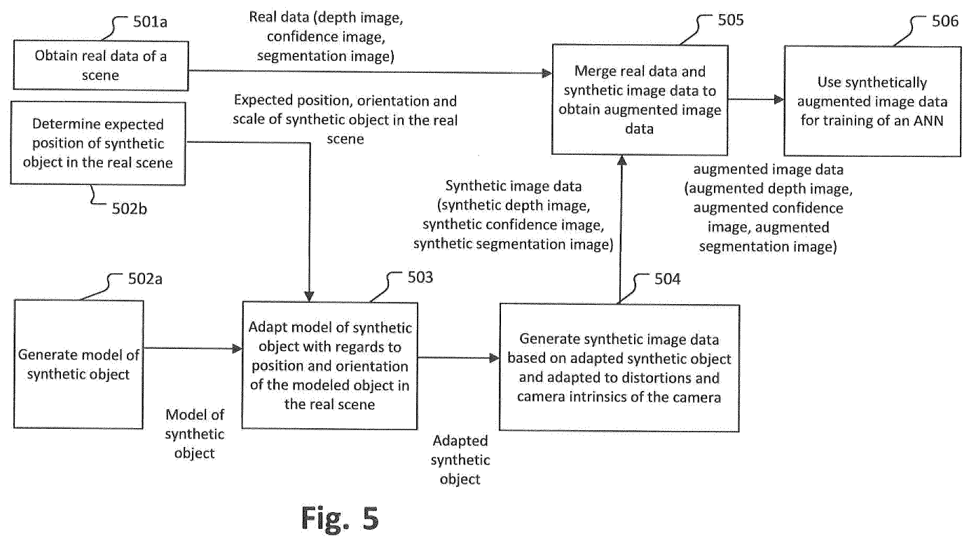

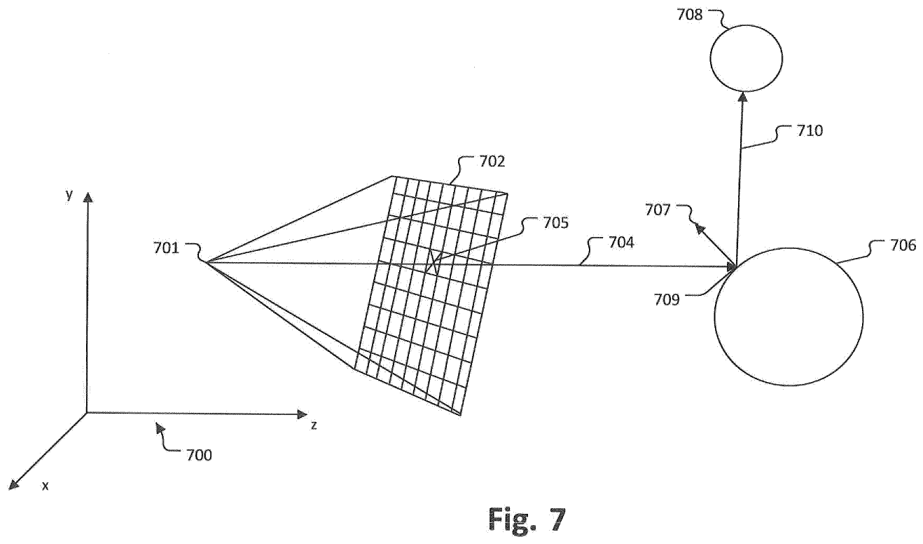

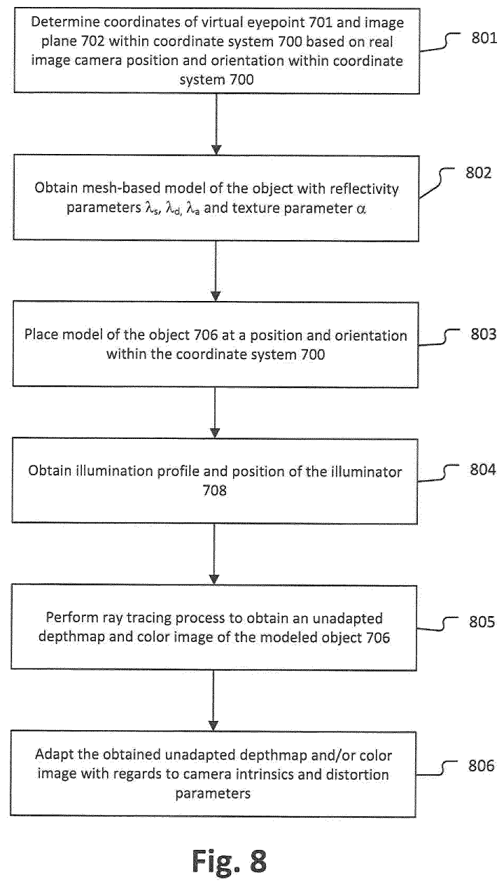

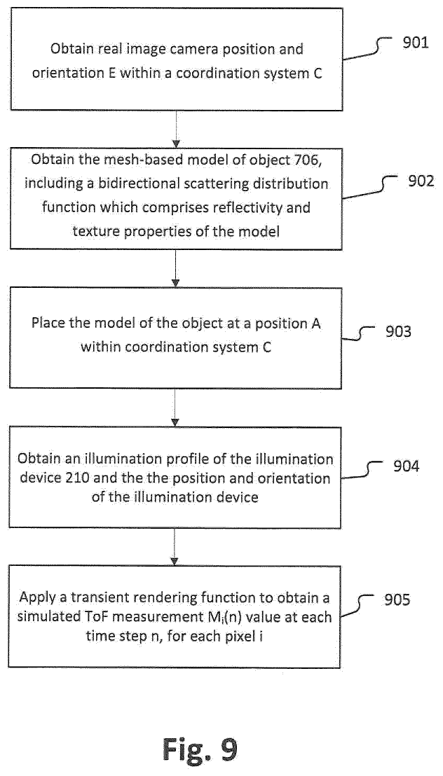

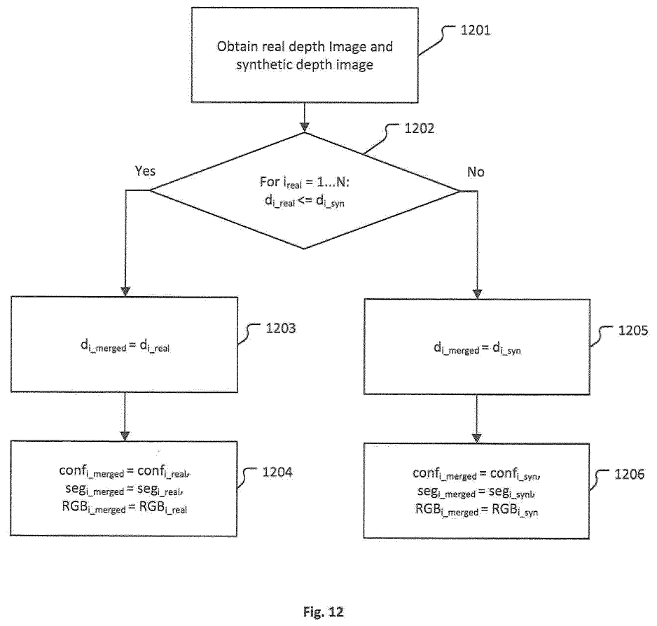

FIG. 5 shows a flow chart of generating an augmented image for ANN training. In step 501a, real data of a (real) scene is obtained from an ToF camera, comprising a depth image (also called depth map), a confidence image, segmentation image. In step 502a, a model of an object is obtained. The model may for example represent the synthetic object (e.g., steering wheel of a vehicle interior) as a mesh-based 3D model in an object coordinate system (e.g., a vehicle coordinate system). The model may also comprise surface reflectivity parameters and/or surface texture parameters for use in a rendering process (see steps 503 and 504 in FIG. 5, and FIGS. 7-9). Further, in step 502b, an expected position, orientation and scale of the modeled object (e.g., the steering wheel) in the real scene is determined (see FIG. 8). For example, the camera is fixed at a certain position and with certain orientation in the vehicle. The position and orientation of the camera in the vehicle coordinate system determines the position and orientation of the synthetic object in the real scene (camera coordinate system) The scale of the synthetic object in the real scene may be obtained by matching the model of the synthetic object to the real scene scales. In step 503, the model of the object is adapted with regards to position, orientation and scale in the real scene. For example, the object may be transformed from the object coordinate system (vehicle coordinate system) to the real space coordinate system (camera coordinate system) based on the expected position and orientation of synthetic object in the real scene. Further, a small randomness may be added to the position, orientation and/or scale of the object to increase the data diversity, for example by adding gaussian distributed noise to the position, orientation and scale. In step 504, a synthetic image data (comprising a depth image, a confidence image, segmentation image and/or color image) of the modeled object is generated based on the adapted synthetic object and further adapted with regards to distortions and camera intrinsics of the camera. The generation may be performed by a rendering process (see FIG. 7 and FIG. 9). The adaptation with regards to the distortions may be applied in order to mimic actual noise of the ToF camera, like specific noise and distortions that occur in an image due to a ToF camera, for example, thermal noise sensor scattering, tap imbalance. The adaptation with regards to the camera intrinsics may be applied due to the fish-eye-lens optics of the ToF sensor etc. (see FIG. 8). In step 505, the real data (comprising a depth image, a confidence image, a segmentation image and/or color image) and the synthetic image data (comprising a depth image, a confidence image, a segmentation image, and/or color image) are merged together to obtain an augmented image data (comprising a depth image, a confidence image, segmentation image and/or color image) are merged together to obtain a synthetically augmented image data (comprising a synthetically augmented depth image, a synthetically augmented confidence image, a synthetically augmented segmentation image and/or a synthetically augmented color image) (see FIG. 12). In step 506, the synthetically augmented image data is used as ground truth data for training of an ANN. Thereby, the generating of segmentation of ground truth images when objects are close to each other is possible.

A synthetic 3D object may be available as a 3D model. The model may be characterized as a mathematical object. The 3D model may also be described by: A mesh, for example comprising reflectivity and/or texture components; a local or global voxel representation of a point cloud (uniform or octree); a local or global occupancy grid; a mathematical description of the scene in terms of planes, statistical distributions (e.g., Gaussian mixture models), or similar attributes extracted from the measured point cloud.

That means, in the real data there may be no two visible objects that are in close vicinity within (e.g., no reflective seat, no reflective steering wheel). However, in the augmented data there may indeed be two visible objects in close vicinity. Therefore, the ANN may be trained on basis of the augmented data to recognize two close objects.

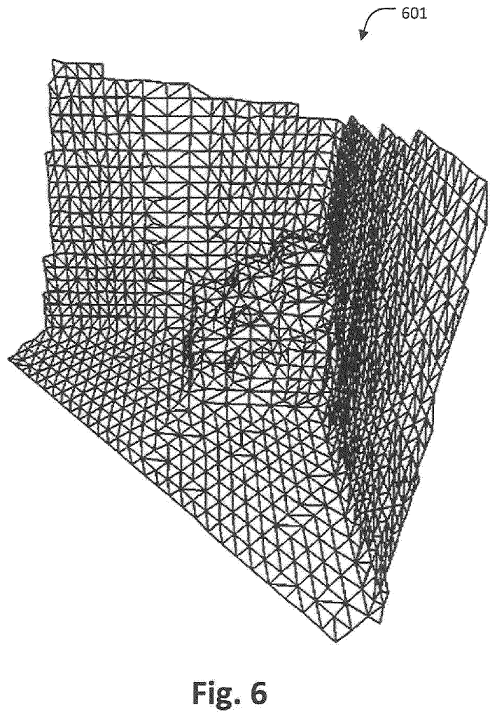

FIG. 6 shows an example of a 3D model of a scene. The scene may comprise one or more objects. The 3D model is implemented as a triangle mesh grid 601. This triangle mesh may be a local or global three-dimensional triangle mesh.

In one embodiment, the 3D model may be a 3D model of a car cabin, or parts thereof, like a steering wheel or a driver seat etc.

In order to generate an image (for example a depth map or a color image or a confidence image) from the 3D model of the object the object has to be rendered. This process of rendering is known to the skilled person and there are several different well-known methods of rendering.

In the embodiment of FIG. 5, a depth image and confidence image are obtained as real data from a ToF camera. In alternative embodiments, the real data may in addition also comprise a color image of gray level image obtained by a CMOS or CCD camera. In still alternative embodiments, the real data may also comprise a color image of gray level image obtained by a CMOS or CCD camera as replacement of the depth image and confidence image of a ToF camera.

### First Embodiment of Rendering

Ray tracing is a technique that is well-known to the person skilled in the art and for example described in more detail in the book “The Ray Tracer Challenge, A test-driven guide to your first 3D renderer”, by Jamis Buck, published in February 2019 by The Pragmatic Programmers, LLC. Further, a different rendering method like rasterization may be used, for instance, the synthetic depth map could be recovered from the rasterization z-buffer, as for example described in the scientific paper “Use of hardware z-buffered rasterization to accelerate ray tracing.”, by Chen, Chih-Chang, and Damon Shing-Min Liu, published in Proceedings of the 2007 ACM symposium on Applied computing. 2007.

FIG. 7 shows the basic principle of ray tracing for rendering a synthetic object. A modeled object 706 (e.g., in the camera coordinate system) which is illuminated by an illuminator 708 is rendered. Therefore, a path of a ray is traced from an imaginary eye 701 through each pixel in an image plane 702, until it intersects with the modeled object 706. The coordinates of a virtual eyepoint 701 (e.g., in the camera coordinate system) and an image plane (e.g., in the camera coordinate system) from which the object 706 should be rendered are obtained within the same coordinate system 700 (e.g., in the camera coordinate system). Ray 704 is traced from the eyepoint 701 through the image plane 702 until it intersects with object 706 at point 709. The ray 704 thereby crossed a pixel 705 in the image plane 702 and therefore the point 709 of the modeled object 706 is imaged in the pixel 705. Therefore, from the coordinate of the point 709 and the coordinate of the image plane within the coordinate system 700, the distance between the image plane and of the point 709 is stored as depth value for the pixel 705. Thereby, a depthmap image of the modeled object 706 may be determined. Further, the coordinate of the illuminator 708 (for example the illumination device 210 from FIG. 1) and an illumination profile and a normal vector 707 are obtained. The illumination profile comprises the luminous intensity and the direction of the illumination by the illuminator 708. Each point within the modeled object 706 may comprise a color value and reflection parameter and/or a texture parameter which are determined by the material of that should be modeled by the object 706. These parameters determine the color and light intensity of the specific pixel. For example, the light intensity of the point 709 that is illuminated by the illuminator 708 via the light ray 710. The reflective illumination intensity of the surface point 709 and therefore of the illumination value of the pixel 705 may be determined based on the so-called Phong reflection model. The Phong reflection model is an empirical model for illumination, and it describes the way a surface reflects light as a combination of the two components: 1. diffuse reflection of rough surfaces and 2. the specular reflection of shiny surfaces. Further, the Phong reflection model also includes a third illumination term that is the ambient term to account for the small amount of light that is scattered about the entire scene. Therefore, the reflective properties of the material of the modeled object 706 may be characterized by: kₛ which is a specular reflection constant (the ratio of reflection of the specular term of incoming light), k_{d} which is a diffuse reflection constant (the ratio of reflection of the diffuse term of incoming light) and kₐ which is an ambient reflection constant (the ratio of reflection of the ambient term present in all points in the scene rendered). Further, the texture of the surface may be determined by a texture parameter γ, which is larger for surfaces that are smoother and more mirror-like. Based on these parameters the according the Phong reflection model provides and intensity value I₇₀₉ for the reflection at the surface point 709. The Phong reflection model is well known in the art and is also described in more detail in the scientific paper “Illumination for computer generated pictures.”, by Phong, Bui Tuong, published in Communications of the ACM 18.6 (1975): 311-317.

FIG. 8 shows a flowchart of a synthetic image generation of a modeled object. In step 801 the coordinates of the virtual eyepoint 701 and image plane 702 are determined within the coordinate system 700 (e.g., in the camera coordinate system) based on the real image camera position and orientation within coordinate system 700. The real image camera and orientation within coordinate system 700 (e.g., in the camera coordinate system) may describe the position and the orientation of the ToF camera by 6 degrees-of-freedom (6DOF), with three DOF for the position and three DOF for the orientation. The three positional DOF are forward/back, up/down, left/right and the three orientational DOF are yaw, pitch, and roll. In step 802, the mesh-based model (e.g., in the object coordinate system) of the object is obtained with reflectivity parameters and texture parameter, for example the parameters with regards to the Phong reflection model (see FIG. 7 above), the specular reflection constant kₛ, the diffuse reflection constant k_{d}, the ambient reflection constant kₐ and surface texture parameter γ. In step 803, the model of the object is placed at a position and orientation within the coordinate system 700 (e.g., in the camera coordinate system). The position and orientation of the modeled object also comprises 6 degrees-of-freedom. In step 804, an illumination profile and the position of the illuminator 708 (for example the illumination device 210 from FIG. 1) are obtained, for example described by means of a time dependent light function. In step 805, a ray tracing process is applied in order to obtain an unadapted depthmap (also called first depth image; meaning: not yet adapted with regards to distortions and camera intrinsics) and/or unadapted color image of the modeled object 706, as described above with FIG. 7. In step 806, a camera intrinsics and distortion transformation is applied to the obtained depthmap and/or color image is adapted with regards to camera intrinsics and distortion parameters. The distortions may be specific noise and distortions that are due to a ToF camera which takes the real image data. For example, the noise that is due to thermal noise, shot noise, lens, and sensor scattering, tap imbalance etc. The camera intrinsics may result in a distortion of the image due to the fish-eye-lens optics of the ToF sensor. The adaption of the image such that the image simulates the camera intrinsics and distortions of camera may be achieved by multiplying the depth values/color values (i.e. for example RGB) or confidence values or the like of each pixel with a certain factor, that is filtering the image. The filtering of the unadapted image may be performed by multiplying the pixel image with a filtering matrix. Theses specific values (of the filtering matrix) may be predetermined through a model of the camera intrinsics and distortion or may be learned by a ANN. For example, the unadapted image may be adapted with regards to the fish-eye optic of the ToF sensor (which is a camera intrinsic) by applying a fish-eye-filter to the unadapted image as for example described in the scientific paper “Three-dimensional simulation method of fish-eye lens distortion for a vehicle backup rear-view camera”, by Kim, Daehee, and Joonki Paik, JOSA A 32.7 (2015): 1337-1343. Steps 805 and 806 may be performed in sequence or at the same time.

A confidence image in this embodiment may be obtained based on a material property called reflectance, which is the normal of the surface and the distance to the camera (which is obtained from the depth map).

In one embodiment a small randomness may be added to the position orientation of the image plane and/or the position, orientation and/or scale of the object 706, for example by adding gaussian distributed noise to the optimal position, orientation and/or scale. Further, noise (for example gaussian distributed noise) may be added to the depthmap, color image or segmentation image.

With regards to step 801, the real image camera position and orientation within the coordinate system 700 (e.g., in the camera coordinate system) may be predetermined and known in advance, for example if the camera is fixed to a certain position, in case of a fixed camera mounted in a car cabin. In another embodiment the camera position may change and may in this case be determined based on the real image by a pose estimation algorithm for example by an ANN which is trained to perform this task or by an approach described as in the scientific paper “KinectFusion: Real-time dense surface mapping and tracking”, by R. A. Newcombe et. al, 2011 10th IEEE International Symposium on Mixed and Augmented Reality, 2011, pp. 127-136.

With regards to step 803, the (optimal) position, scale and the orientation of the modeled object within the coordinate system 700 (e.g., in the camera coordinate system) may be predetermined and known in advance for example in a case where the camera is fixed to a certain position with known coordinates and a model of the object is modeled in a space with the same coordinates. This may be the case, if a fixed camera is mounted in a car cabin and the object is a model of the interior of the same car cabin which comprises the camera position which takes the real image.

### Second Embodiment of Rendering

The render may be a transient renderer, like it is for example disclosed in the scientific paper “Transient rendering”, by Smith, Adam, James Skorupski, and James Davis, published in 2008. That means, wherein classic rendering equations do in general not encompass the transient effects of light propagation at finite speeds and instead assumes an infinite speed of light an, the transient rendered does include these transient effects. In ToF applications, a distinction between steady-state (i.e. speed of light assumed to be infinite) and transient light transport (i.e. speed of light assumed to be finite) may be important.

FIG. 9 shows a flowchart of a transient rendering process to obtain a transient image X, for example according to the scientific paper “Transient rendering”, by Smith, Adam, James Skorupski, and James Davis, published in 2008. In step 901 the real image camera position and orientation E (also called eyepoint) within a coordinate system C (e.g., in the camera coordinate system) is obtained. The real image camera position and orientation E within the coordinate system C may describe the position and the orientation of the ToF camera by 6 degrees-of-freedom (6DOF). In step 902, the mesh-based model of the object 706 is obtained, including a bidirectional scattering distribution function (BSDF) which comprises reflectivity and texture properties of the (surface) of the model. In step 903, the model of the object is placed at a position A within coordinate system C (e.g., in the camera coordinate system), wherein the position A of the modeled object also comprises 6 degrees-of-freedom. In step 904, an illumination profile of the illumination device 210 (see 210 in FIG. 1) is obtained, for example described by a time dependent light function Light (t). Further, the position L of the illumination device 210 may be obtained within the coordinate system C. Further, an exposure function Exposure (t) (for example a box function) is obtained. In step 905, a transient rendering function is applied to render the modeled object 706, for example the transient photometric response function (TPRF) as described in the scientific paper “Transient rendering”, by Smith, Adam, James Skorupski, and James Davis, published in 2008. This yields a (simulated) ToF measurement value Mᵢ(n) (for example the measured charges at time step n) at each time step n, for each pixel i, which yields a histogram (see FIG. 8). Combining all n measurement values Mᵢ(n) for a certain pixel yields a transient image Xᵢ for each pixel i.

In one embodiment a small randomness may be added to the position and orientation of the camera plane and/or the position, orientation and/or scale of the object, for example by adding gaussian distributed noise to the position and orientation.

With regards to step 901, the real image camera position E within the coordinate system C (e.g., in the camera coordinate system) may be predetermined and known in advance, for example if the camera is fixed to a certain position, in case of a fixed camera mounted in a car cabin. In another embodiment the camera position may change and may in this case be determined based on the real image by a pose estimation algorithm for example by an ANN which is trained to perform this task or by an approach described as in the scientific paper “KinectFusion: Real-time dense surface mapping and tracking”, by R. A. Newcombe et. al, 2011 10th IEEE International Symposium on Mixed and Augmented Reality, 2011, pp. 127-136.

With regards to step 903, the position, scale and orientation of the modeled object within the coordinate system C (e.g., in the camera coordinate system) may be predetermined and known in advance for example in a case where the camera is fixed to a certain position with known coordinates and a model of the object is modeled in a space with the same coordinates. This may be the case if for example in case of a fixed camera mounted in a car cabin and the object is a model of the interior of the same car cabin which comprises the camera position which takes the real image.

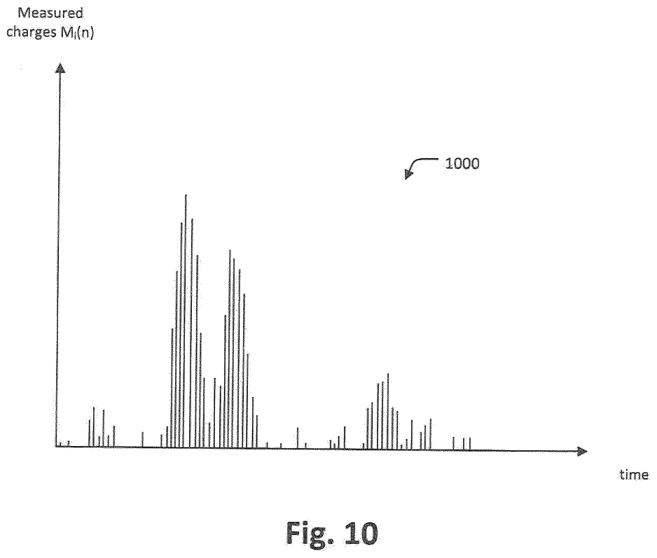

FIG. 10 shows a histogram of simulated measurement values Mᵢ(n) of a transient rendering process as described in FIG. 9. The x-axis of the histogram 1000 shows a timeline. The timeline may for example be discrete and each discrete point may stand for a bin of 5 ns. The y-axis of the histogram 1000 shows the simulated measured energy Mᵢ(n) for each pixel i, for example for the simulated measured energy Mᵢ(n) the during a time period of 5 ns.

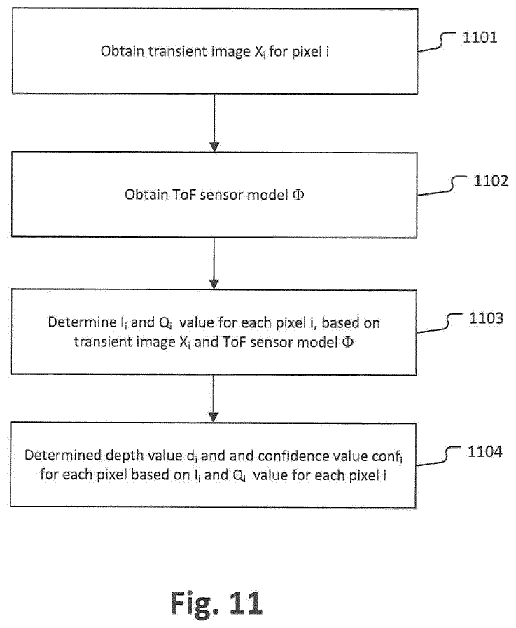

FIG. 11 shows the flow chart of an applying sensor model to the transient image Xᵢ. In step 1101, the transient image Xᵢ is obtained for pixel i. In step 1102, an ToF sensor model φ is obtained. The ToF model estimates the ToF output from a ToF sensor by emulating ToF camera modulation and demodulation signals. These are convolved with the transient image to obtain a realistic camera response given the modulation waveform. Therefore, the sensor model φ may be derived from the ToF equations described with FIG. 1. The sensor model φ may consist of a matrix with four rows and as many columns as the time bins of the histogram of each pixel measurement Mᵢ(n) in the transient image Xᵢ. Each row of φ is a cosine function with a different internal phase shift α∈[0π/2,π, 3π/2]. Through the matrix multiplication mᵢ=φXᵢ, which holds at every pixel i in the sensor array simulate a four-taps (in another embodiment another number of taps for example 2 or more may be simulated) sampling of an ToF. Moreover, distortions like sensor-related noise and distortion sources, for example, thermal noise, shot noise, lens, and sensor scattering, tap imbalance are also part of the ToF sensor model Q.

In step 1103, the Iᵢ and Qᵢ values are determined for each pixel based on the sensor model φ and the transient image Xᵢ. That is, from m we can then build the corresponding Iᵢ and Qᵢ values for each pixel as follows:

$${I}_{i} = {m}_{i , 0} - {m}_{i , π} ; {Q}_{i} = {m}_{i , \frac{3 π}{2}} - {m}_{i , \frac{π}{2}} \qquad ( Eq . 20 )$$

where the subscripts denote the corresponding internal phase shift α.

In step 1104, depth value dᵢ for each pixel and the confidence value confᵢ for each pixel i are determined based on the Iᵢ and Qᵢ values. That is, based on the equations Eq. 17-Eq. 19. Further, the segmentation label for each pixel i is known by definition because the modeled object determines the segmentation label. This process is performed for each pixel i.

Thereby, the camera intrinsics and distortions of the ToF camera may be modeled by the ToF sensor model φ.

Further the camera intrinsics and distortions may be applied instead or additional to the image by multiplying the depth values/color values (i.e. for example RGB) or confidence values or the like of each pixel with a certain factor, that is filtering the image as described above. The filtering of the unadapted image may be performed by multiplying the pixel image with a filtering matrix. Theses specific values (of the filtering matrix) may be predetermined through a model of the camera intrinsics and distortion or may be learned by a ANN. For example, the unadapted image may be adapted with regards to the fish-eye optic of the ToF sensor (which is a camera intrinsic) by applying a fish-eye-filter to the unadapted image as for example described in the scientific paper “Three-dimensional simulation method of fish-eye lens distortion for a vehicle backup rear-view camera”, by Kim, Daehee, and Joonki Paik, JOSA A 32.7 (2015): 1337-1343. Further, noise (for example gaussian distributed noise) may be added to the depthmap, confidence image, and/or segmentation image.

### Merging of Real Image and Synthetic Image

FIG. 12 shows a flow chart of a merging of real image data and synthetic image data. In step 1201, the real depth image and the synthetic depth image are obtained. In step 1202, a for loop is started from i=1 . . . N, wherein N is the total number of pixels within the real image (which is the same as in the synthetic image): It is asked if the depth value of the real image dᵢ_{ᵣₑₐₗ} is smaller or equal than the depth value of the synthetic image dᵢ_{_{syn}}:dᵢ_{ᵣₑₐₗ}≤dᵢ_{_{syn}}. If the answer in step 1202 is yes, it is proceeded with step 1203. In step 1203, the depth value dᵢ_{_{merged}} of the corresponding pixel i_{merged} in a merged depth image is set as the depth value of the real image, dᵢ_{_{merged}}=dᵢ_{ᵣₑₐₗ}. In step 1204, the confidence value of the corresponding pixel i_{merged} of a merged confidence image confᵢ_{_{merged}} is set as, confᵢ_{_{merged}}=confᵢ_{ᵣₑₐₗ}, the segmentation value of the corresponding pixel i_{merged} of a merged segmentation image segᵢ_{_{merged}} is set as segᵢ_{_{merged}}=segᵢ_{ᵣₑₐₗ} and/or color value of the corresponding pixel i_{merged} of a merged color image RGBᵢ_{_{merged}} is set as, RGBᵢ_{_{merged}}=RGBᵢ_{ᵣₑₐₗ}). If the answer in step 1202 is no, it is proceeded with step 1205. In step 1205, the depth value dᵢ_{_{merged}} of the corresponding pixel merged in a merged depth image is set as the depth value of the synthetic image, dᵢ_{_{merged}}=dᵢ_{_{syn}}. In step 1206, the confidence value of the corresponding pixel i_{merged} of a merged confidence image confᵢ_{_{merged}} is set as, confᵢ_{_{merged}}=confᵢ_{_{syn}}, the segmentation value of the corresponding pixel i_{merged} of a merged segmentation image segᵢ_{_{merged}} is set as segᵢ_{_{merged}}=segᵢ_{_{syn}} and/or color value of the corresponding pixel i_{merged} of a merged color image RGBᵢ_{_{merged}} is set as, RGBᵢ_{_{merged}}=RGBᵢ_{_{syn}}.

By comparing the available depth values of the real image depth map and the synthetic depth image, the so-called occlusion problem when merging images is solved. That means, it is clear which of the merged images is visible and which is invisible at each pixel by knowing the depth value at each pixel.

FIG. 13. shows a real image and a synthetically augmented image. Image 1301 is real confidence image. Image 1302 is synthetically augmented confidence image. Image 1303 is real depth image. Image 1304 is synthetically augmented depth image. Image 1305 is real segmentation image. Image 1306 is synthetically augmented segmentation image.

### Implementation

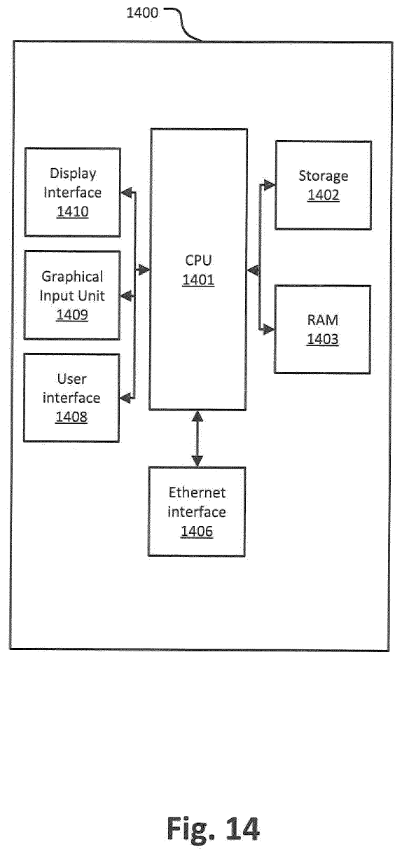

FIG. 14 schematically describes an embodiment of an electronic device which may implement the functionality of an artificial neural network. The electronic device 1400 comprises a CPU 1401 as processor. The electronic device 1400 further comprises a GPU 1409 that is connected to the processor 1401. The electronic system 1400 further comprises an Ethernet interface 1406 which acts as interface for data communication with external devices. The electronic device 1400 further comprises a data storage 1402 and a data memory 1403 (here a RAM). The data memory 1403 is arranged to temporarily store or cache data or computer instructions for processing by the processor 1401. The data storage 1402 is arranged as a long-term storage, e.g., for images. The electronic device 1400 further comprises a graphical input unit. The electronic device 1400 further comprises a display interface 1410 which could be a touch screen display.

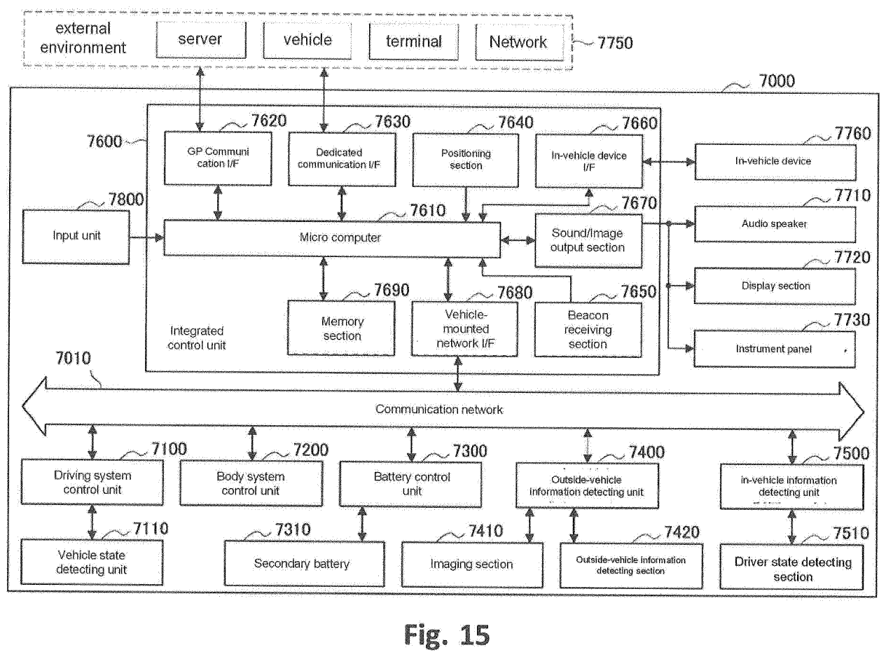

The electronic device 1400 may be also implemented in the integrated control unit 7600 of FIG. 15. Further, the technology according to an embodiment of the present disclosure is applicable to various products. For example, the technology according to an embodiment of the present disclosure may be implemented as a device included in a mobile body that is any of kinds of automobiles, electric vehicles, hybrid electric vehicles, motorcycles, bicycles, personal mobility vehicles, airplanes, drones, ships, robots, construction machinery, agricultural machinery (tractors), and the like.

FIG. 15 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 15, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 15 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The integrated control unit 7600 may implement the generation of training data for an ANN comprising synthetically augmented depth/segmentation/confidence/color images generated as described above. Further, the integrated control unit 7600 may implement the training of an ANN with training data comprising synthetically augmented depth/segmentation/confidence/color images generated as described above. Further, the integrated control unit 7600 may implement the storing of a trained ANN, which was trained with training data comprising synthetically augmented depth/segmentation/confidence/color images generated as described above.

The in-vehicle information detecting unit 7500 may comprise a ToF camera or the like in order to obtain depth/confidence/color images which may then be synthetically augmented as described above. Further, the in-vehicle information detecting unit 7500 may utilize an ANN which was trained with training data comprising synthetically augmented depth/segmentation/confidence/color images generated as described above.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera (see FIG. 1), a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device) or an ToF camera. Each of the imaging section 7410 and the outside-vehicle information detecting section 7420 may be provided as an independent sensor or device, or may be provided as a device in which a plurality of sensors or devices are integrated.

It should be noted that the description above is only an example configuration. Alternative configurations may be implemented with additional or other sensors, storage devices, interfaces, or the like.

It should be recognized that the embodiments describe methods with an exemplary ordering of method steps. The specific ordering of method steps is, however, given for illustrative purposes only and should not be construed as binding.

It should also be noted that the division of the electronic device of FIGS. 1, 14 and 15 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below:
(1) A method for generating a synthetically augmented depth image as training data for training of an artificial neural network (300) comprising:
   generating (step 503; step 504) a depth image of a synthetic object (706); and
   merging (step 505) a real depth image of a scene (101) with the generated depth image of the synthetic object (706) to obtain the synthetically augmented depth image.
(2) The method of (1) further comprising:
   generating (step 503; step 504) a segmentation image of the synthetic object (706); and
   merging a real segmentation image of the scene (101) with the generated segmentation image of the synthetic object (706) to obtain the synthetically augmented segmentation image.
(3) The method of (1) or (2) further comprising:
   generating (step 503; step 504) a confidence image of the synthetic object (706); and
   merging a real confidence image of the scene (101) with the generated confidence image of the synthetic object (706) to obtain the synthetically augmented confidence image.
(4) The method of anyone of (1) to (3), wherein the generating of a depth image comprises adapting (step 504; step 806) an unadapted depth image of the synthetic object with regards to camera intrinsics and distortions of a camera taking the real depth image.
(5) The method of (4), wherein the distortions of the camera taking the real depth image are due to thermal noise, shot noise, sensor scattering, tap imbalance and the camera intrinsic distortions are due to a fish-eye-lens optics the camera.
(6) The method of anyone of (1) to (5), wherein the generating of the depth image of the synthetic object (706) comprises adding noise to the position, orientation and/or scale of the synthetic object (706) with regards to an optimal position, orientation and/or scale of the synthetic object.
(7) The method of anyone of (1) to (6), wherein the merging of the real depth image of the scene (101) with the generated depth image of the synthetic object (706) comprises comparing (step 1202) corresponding depth values of pixels of the real depth image and the generated depth image of the synthetic object (706).
(8) The method of (7), wherein the respective pixel value with the lower depth value is set as the depth value of the synthetically augmented depth image.
(9) The method of anyone of (1) to (8), wherein a camera generating the real depth image of the scene (101) is a time-of-flight camera or structured light camera or a stereo camera.
(10) The method of anyone of (1) to (9), wherein the generating of the depth image of the synthetic object (706) comprises performing (step 805) a ray tracing process or rasterization.
(11) The method of anyone of (1) to (10), wherein the generating of the depth image comprises performing (step 905) a transient rendering process.
(12) The method of anyone of (1) to (11), wherein the synthetic object is a 3D mesh model (601).
(13) The method of anyone of (1) to (12), wherein the synthetic object (706) comprises a surface reflectivity parameter (kₛ, kₐ, kₐ) and/or surface texture parameter (γ).
(14) The method of anyone of (1) to (13), wherein the synthetically augmented depth image is used as training data for training of an artificial neural network (300) for an automotive functional safety application.
(15) A method for training an artificial neural network (300) with a synthetically augmented depth image and a synthetically augmented segmentation image, wherein generating the synthetically augmented depth image and the synthetically augmented segmentation comprises:
   generating (step 503; step 504) a depth image of a synthetic object; and
   merging (step 505) a real depth image of a scene (101) with the generated depth image of the synthetic (706) object to obtain the synthetically augmented depth image.
(16) A device comprising circuitry configured to implement an artificial neural network (300) obtained by being trained with a synthetically augmented depth image and a synthetically augmented segmentation image, wherein generating the synthetically augmented depth image and the synthetically augmented segmentation comprises:
   generating (step 503; step 504) a depth image of a synthetic object; and
   merging (step 505) a real depth image of a scene (101) with the generated depth image of the synthetic (706) object to obtain the synthetically augmented depth image.

1. A method for generating a synthetically augmented depth image as training data for training of an artificial neural network comprising:
generating a depth image of a synthetic object; and
merging a real depth image of a scene with the generated depth image of the synthetic object to obtain the synthetically augmented depth image.

2. The method of claim 1 further comprising:
generating a segmentation image of the synthetic object; and
merging a real segmentation image of the scene with the generated segmentation image of the synthetic object to obtain the synthetically augmented segmentation image.

3. The method of claim 1 further comprising:
generating a confidence image of the synthetic object; and
merging a real confidence image of the scene with the generated confidence image of the synthetic object to obtain the synthetically augmented confidence image.

4. The method of claim 1, wherein the generating of a depth image comprises adapting an unadapted depth image of the synthetic object with regards to camera intrinsics and distortions of a camera taking the real depth image.

5. The method of claim 4, wherein the distortions of the camera taking the real depth image are due to thermal noise, shot noise, sensor scattering, tap imbalance and the camera intrinsic distortions are due to a fish-eye-lens optics the camera.

6. The method of claim 1, wherein the generating of the depth image of the synthetic object comprises adding noise to the position, orientation and/or scale of the synthetic object with regards to an optimal position, orientation and/or scale of the synthetic object.

7. The method of claim 1, wherein the merging of the real depth image of the scene with the generated depth image of the synthetic object comprises comparing corresponding depth values of pixels of the real depth image and the generated depth image of the synthetic object.

8. The method of claim 7, wherein the respective pixel value with the lower depth value is set as the depth value of the synthetically augmented depth image.

9. The method of claim 1, wherein a camera generating the real depth image of the scene is a time-of-flight camera or structured light camera or a stereo camera.

10. The method of claim 1, wherein the generating of the depth image of the synthetic object comprises performing a ray tracing process or rasterization.

11. The method of claim 1, wherein the generating of the depth image comprises performing a transient rendering process.

12. The method of claim 1, wherein the synthetic object is a 3D mesh model.

13. The method of claim 1, wherein the synthetic object comprises a surface reflectivity parameter and/or surface texture parameter.

14. The method of claim 1, wherein the synthetically augmented depth image is used as training data for training of an artificial neural network for an automotive functional safety application.

15. A method for training an artificial neural network with a synthetically augmented depth image and a synthetically augmented segmentation image, wherein generating the synthetically augmented depth image and the synthetically augmented segmentation comprises:
generating a depth image of a synthetic object; and
merging a real depth image of a scene with the generated depth image of the synthetic object to obtain the synthetically augmented depth image.

16. A device comprising circuitry configured to implement an artificial neural network obtained by being trained with a synthetically augmented depth image and a synthetically augmented segmentation image, wherein generating the synthetically augmented depth image and the synthetically augmented segmentation comprises:
generating a depth image of a synthetic object; and
merging a real depth image of a scene with the generated depth image of the synthetic object to obtain the synthetically augmented depth image.

17. A method for generating a synthetically augmented depth image as claimed in claim 1, wherein the real depth image of the scene represents a cabin interior of a vehicle and the synthetic object represents at least one of a steering wheel, a vehicle seat, and a driver body.

18. A method for generating a synthetically augmented depth image as claimed in claim 2, wherein the real depth image of the scene represents segmentation images of cabin interior of a vehicle and the segmentation image of the synthetic object represents at least one of, at least part of, a steering wheel, a vehicle seat, and a driver body, and the output of the merging comprises a plurality of labelled pixel data distinguishing objects close to one another in the synthetically augmented depth image.

19. The method of claim 17, wherein the generating of the depth image of the synthetic object comprises adding noise to the position, orientation and/or scale of the synthetic object with respect to co-ordinates of a position, orientation and/or scale of the synthetic object to represent the synthetic object in the cabin interior as the synthetically augmented depth image.

20. A method for generating a synthetically augmented depth image, further comprising
using the synthetically augmented depth image as training data for training of an artificial neural network for use in making functional automotive safety decisions.
